(19) United States
(12) Patent Application Publication
(10) Pub. No.: US 2026/0150031 A1
(43) Pub. Date: May 28, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Li NIU, Shenzhen (CN); Bo DAI, Shenzhen (CN); Ting LU, Shenzhen (CN); Yuan GAO, Shenzhen (CN)

(73) Assignee: ZTE CORPORATION, Shenzhen (CN)

(21) Appl. No.: 19/278,503

(22) Filed: Jul. 23, 2025

Related U.S. Application Data
(63) Continuation of application No. PCT/CN2023/091902, filed on Apr. 28, 2023.

(51) Int. Cl. H04W 40/22; H04W 4/70; H04W 76/14

(52) U.S. Cl. CPC H04W 40/22; H04W 4/70; H04W 76/14

(57) ABSTRACT

A wireless communication method is disclosed. The method comprises receiving, by a relay wireless communication terminal from a wireless communication node, configuration information for a communication between the wireless communication node and an Internet of Things, IoT, wireless communication terminal; and relaying, by the relay wireless communication terminal, IoT information for the communication between the wireless communication node and the IoT wireless communication terminal according to the configuration information.

### CROSS-REFERENCE TO RELATED PATENT APPLICATIONS

This application is a Continuation of US Application PCT/CN2023/091902, filed Apr. 28, 2023, incorporated herein by reference in its entirety.

### TECHNICAL FIELD

This document is directed generally to wireless communications, and in particular to 5th generation (5G) communications or 6th generation (6G) communications.

### BACKGROUND

In recent years, Internet of Things (IoT) based on NB-IoT (Narrowband Internet of Things) and eMTC (enhanced Machine Type Communication) technologies has been widely used or tested in various applications such as smart grid, intelligent parking, intelligent transportation and logistics, smart energy management systems, etc., involving many vertical fields such as smart cities and smart homes. This has rapidly promoted the upgrading and transformation of traditional industries. For example, the smart parking system can meet the deep coverage requirements of underground scenarios, and can achieve various functions such as parking space search, parking lot monitoring, and zone information display based on multiple types of sensors. In the smart grid system, functions such as intelligent meter reading and autonomous fault reporting can be realized. The IoT system based on eMTC technology can realize vehicle tracking, item tracking, and can be applied to transportation and logistics industry, shared bicycle industry, etc.

### SUMMARY

The large-scale application of IoT technology will give rise to a more diverse market and technological demands, and new IoT applications will continue to emerge. It is foreseeable that a larger number of sensors, IoT devices, or other types of modules will penetrate into various traditional or emerging industries such as agriculture, industry, environmental protection, urban management, and human health. In a smart library, for example, all books may be equipped with electronic tags, and the movement of books throughout the library can be fully tracked, with real-time book searching, positioning, quantity or status statistics, and more. The warehousing and logistics industry may already be a highly automated industry, where administrators can achieve electronic item recording, querying, and tracking through RFID (Radio Frequency Identification) technology-based tags. However, the workload is still enormous, as specialized equipment is needed to read each tag in sequence. People expect more intelligent operations. Due to economic constraints, traditional agriculture may still not be as modernized as expected, but it will become more modernized and intelligent in the future. Various sensors can be used for real-time monitoring of crop growth conditions such as soil, water, light, fertility, pests, and crop growth, and monitoring data can be used to drive small controllers to adjust growth conditions in real-time and handle disasters in a timely manner. Some potential applications may relate to advanced wearable or medical devices, including patches that can be attached to teeth to monitor oral health or diet, and micro-robots that can enter blood vessels for disease treatment, and so on. Overall, these applications will present significantly different requirements from existing IoT applications. For example, the number of such devices will be enormous, the size of many devices will be very small, requiring extremely simple hardware structures, and even the inability to integrate batteries. In addition, even if these devices can integrate batteries, it may be difficult to ensure that a battery can last for a long time due to the wide variety of business models. However, due to the enormous number of these devices, charging or replacing batteries for them will become very difficult, requiring tremendous manpower and material resources, and may even become an impossible task.

This document relates to methods, systems, and computer program products for an IoT relay communication.

One aspect of the present disclosure relates to a wireless communication method. In an embodiment, the wireless communication method includes: receiving, by a relay wireless communication terminal from a wireless communication node, configuration information for a communication between the wireless communication node and an Internet of Things, IoT, wireless communication terminal; and relaying, by the relay wireless communication terminal, IoT information for (or via) the communication between the wireless communication node and the IoT wireless communication terminal according to the configuration information.

Another aspect of the present disclosure relates to a wireless communication method. In an embodiment, the wireless communication method includes: transmitting, by a wireless communication node to a relay wireless communication terminal, configuration information for a communication between the relay wireless communication terminal and an Internet of Things, IoT, wireless communication terminal to allow the relay wireless communication terminal to relay IoT information for (or via) the communication between the wireless communication node and the IoT wireless communication terminal according to the configuration information.

Another aspect of the present disclosure relates to a wireless communication method. In an embodiment, the wireless communication method includes: performing, by an Internet of Things, IoT, wireless communication terminal, a communication between a wireless communication node and the IoT wireless communication terminal via a relay wireless communication terminal based on configuration information provided by the wireless communication node.

Another aspect of the present disclosure relates to a wireless communication terminal. In an embodiment, the wireless communication terminal includes a communication unit and a processor. The processor is configured to: receive, via the communication unit from a wireless communication node, configuration information for a communication between the wireless communication node and an Internet of Things, IoT, wireless communication terminal; and relay, via the communication unit, IoT information for the communication between the wireless communication node and the IoT wireless communication terminal according to the configuration information.

Another aspect of the present disclosure relates to a wireless communication node. In an embodiment, the wireless communication node includes a communication unit and a processor. The processor is configured to: transmit, via the communication unit to a relay wireless communication terminal, configuration information for a communication between the relay wireless communication terminal and an Internet of Things, IoT, wireless communication terminal to allow the relay wireless communication terminal to relay IoT information for the communication between the wireless communication node and the IoT wireless communication terminal according to the configuration information.

Another aspect of the present disclosure relates to a wireless communication terminal. In an embodiment, the wireless communication terminal includes a communication unit and a processor. The processor is configured to: perform, via the communication unit, a communication between a wireless communication node and the IoT wireless communication terminal via a relay wireless communication terminal based on configuration information provided by the wireless communication node.

Various embodiments may preferably implement the following features:

Preferably or in some embodiments, the configuration information comprises at least one of:
frequency information for the communication between the wireless communication node and the IoT wireless communication terminal according to the configuration information;
bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a time resource for the communication between the wireless communication node and the IoT wireless communication terminal according to the configuration information;
a common configuration of an IoT Uu interface;
a common configuration of an IoT Layer B entity;
a required feedback format; or
a common configuration of at least one of a Data Radio Bearer, DRB, a Signaling Radio Bearer, SRB, a Radio Bearer, RB, or a Radio Link Control, RLC, channel.

Preferably or in some embodiments, the common configuration of the IoT Uu interface comprises at least one of:
a common configuration of an IoT Layer 1 entity;
a common configuration of an IoT Layer 2 entity; or
a common configuration of an IoT Layer 3 entity.

Preferably or in some embodiments, the configuration information conforms with at least one of:
the common configuration of the DRB comprising at least one of: a Uu physical, PHY, configuration, a Uu Medium Access Control, MAC, configuration, a Uu RLC configuration, a Uu Packet Data Convergence Protocol, PDCP, configuration, a Uu Service Data Adaption Protocol, SDAP, configuration, or a DRB identity;
the common configuration of the SRB comprising at least one of: a Uu physical, PHY, configuration, a Uu Medium Access Control, MAC, configuration, a Uu RLC configuration, a Uu Packet Data Convergence Protocol, PDCP, configuration, a Uu Radio Resource control, RRC, configuration, or an SRB identity;
the common configuration of the RB comprising at least one of: a Uu PHY configuration, a Uu MAC configuration, a Uu RLC configuration, a Uu PDCP configuration, or an RB identity; or
the common configuration of the RLC channel comprising at least one of: a Uu PHY configuration a Uu MAC configuration, a Uu RLC configuration, or an RLC channel identity.

Preferably or in some embodiments, the configuration information comprises at least one of:
dedicated frequency information for the communication between the wireless communication node and the IoT wireless communication terminal according to the configuration information;
dedicated bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a dedicated time resource for the communication between the wireless communication node and the IoT wireless communication terminal according to the configuration information;
an indication of a release, an establishment, or a modification of one or more dedicated configurations of an IoT Uu interface;
an indication of a release, an establishment, or a modification of a dedicated configuration of an IoT Layer B entity;
a required feedback format; or
a dedicated configuration for relaying a data packet from the relay wireless communication terminal to the IoT wireless communication terminal.

Preferably or in some embodiments, the one or more dedicated configurations of the IoT Uu interface comprises at least one of:
a dedicated configuration of an IoT Layer 1 entity;
a dedicated configuration of an IoT Layer 2 entity; or
a dedicated configuration of an IoT Layer 3 entity.

Preferably, the dedicated configuration for relaying the data packet comprises at least one of:
an indication of a release, an establishment, or a modification of one or more dedicated configurations of a DRB;
an indication of a release, an establishment, or a modification of one or more dedicated configurations of an RB;
an indication of a release, an establishment, or a modification of one or more dedicated configurations of an SRB;
an indication of a release, an establishment, or a modification of one or more dedicated configurations of an RLC channel;
an indication indicating a relaying function; or
a mapping relationship between a DRB, SRB, RB or RLC channel and an IoT Layer 1, Layer 2, or Layer 3 entity.

Preferably or in some embodiments, the relay wireless communication terminal transmits a capability of a relay function for the IoT wireless communication terminal to a network node.

Preferably or in some embodiments, the capability comprises at least one of:
an indication indicating whether the relay wireless communication terminal supports relaying the IoT information the IoT wireless communication terminal;
an indication indicating whether the relay wireless communication terminal supports an inventory procedure for the IoT wireless communication terminal;
an indication indicating whether the relay wireless communication terminal supports an energy supply for the IoT wireless communication terminal; or
an indication indicating a relay architecture supported by the relay wireless communication terminal.

Preferably or in some embodiments, the relay wireless communication terminal receives an IoT relay service authorization for a relay function for the IoT wireless communication terminal from a network node, wherein IoT relay service authorization comprises at least one of:
an indication indicating whether the relay wireless communication terminal is authorized to support relaying the IoT information for the IoT relay wireless communication terminal;
an indication indicating whether the relay wireless communication terminal is authorized to support an inventory procedure for the IoT wireless communication terminal;
an indication indicating whether the relay wireless communication terminal is authorized to support an energy supply for the IoT wireless communication terminal;
an indication indicating a relay architecture that the relay wireless communication terminal is authorized to support by the relay wireless communication terminal;
an IoT relay Aggregate Maximum Bit Rate, AMBR, used by the wireless communication node for a resource management of the relay wireless communication terminal relaying the IoT information in a network scheduled mode; or
IoT relay quality of service, QoS, parameters for an IoT relay communication used by the wireless communication node for a resource management for the relay wireless communication terminal relaying the IoT information in a network scheduled mode.

Preferably or in some embodiments, the relay wireless communication terminal receives indication information from the wireless communication node, and reports assistance information to the wireless communication node based on indication information.

Preferably, the indication information comprises at least one of:
an indication indicating that the relay wireless communication terminal could is able to report whether it is interested in relaying the IoT information for the communication between the wireless communication node and the IoT wireless communication terminal;
an indication indicating that the relay wireless communication terminal is able to could report whether it is interested in an inventory for the IoT wireless communication terminal;
an indication indicating that the relay wireless communication terminal is able to could report whether it is interested in supplying energy for the IoT wireless communication terminal;
an indication indicating that the relay wireless communication terminal is able to information of requesting or releasing release a transmission resource for relaying the IoT the indication that the relay wireless communication terminal could report information for the communication between the wireless communication node and the IoT wireless communication terminal;
an indication indicating that the relay wireless communication terminal is able to report information of requesting or releasing supplying energy for the IoT wireless communication terminal;
an indication indicating that the relay wireless communication terminal is able to report an indication of requesting or releasing an inventory for the IoT wireless communication terminal; or
an indication indicating that the relay wireless communication terminal is able to report information of quality of service, QoS, parameters and one or more QoS profiles related to relaying the IoT information for the communication between the wireless communication node and the IoT wireless communication terminal.

Preferably or in some embodiments, the relay wireless communication terminal transmits assistance information to the wireless communication node.

Preferably or in some embodiments, the assistance information comprises at least one of:
an indication indicating whether the relay wireless communication terminal is interested in relaying the IoT information for the communication between the wireless communication node and the IoT wireless communication terminal;
an indication indicating whether the relay wireless communication terminal is interested in an inventory for the IoT wireless communication terminal;
an indication indicating whether the relay wireless communication terminal is interested in supplying energy for the IoT wireless communication terminal;
information of requesting or releasing a transmission resource for relaying the IoT information for the communication between the wireless communication node and the IoT wireless communication terminal;
information of requesting or releasing supplying energy for the IoT wireless communication terminal;
an indication of requesting or releasing an inventory for the IoT wireless communication terminal; or
information of quality of service, QoS, parameters and one or more QoS profiles related to relaying the IoT information for the communication between the wireless communication node and the IoT wireless communication terminal.

Preferably or in some embodiments, the relay wireless communication terminal receives a message from the wireless communication node for at least one of waking up the IoT wireless communication terminal or triggering an inventory procedure for the IoT wireless communication terminal.

Preferably or in some embodiments, the message comprises at least one of:
an indication enabling a wake-up signal for the IoT wireless communication terminal;
time information of a wake-up signal for the IoT wireless communication terminal;
a configuration of a wake-up signal for the IoT wireless communication terminal;
information of the inventory procedure for the IoT wireless communication terminal; or
information of a contention resolution.

Preferably or in some embodiments, the relay wireless communication terminal receives a trigger signal from the wireless communication node and supplies energy to the IoT wireless communication terminal according to the trigger signal.

Preferably or in some embodiments, the trigger signal comprises at least one of:
an indication enabling or disabling an energy signal supplying energy to the IoT wireless communication terminal;
a physical configuration of an energy signal supplying energy to the IoT wireless communication terminal;
a power level of an energy signal supplying energy to the IoT wireless communication terminal;
a signal type of an energy signal supplying energy to the IoT wireless communication terminal; or
time information of an energy signal supplying energy to the IoT wireless communication terminal.

Preferably or in some embodiments, the relay wireless communication terminal receives identity information from the wireless communication node and relaying the IoT information for the communication between the wireless communication node and the IoT wireless communication terminal according to the identity information.

Preferably or in some embodiments, the identity information comprises at least one of:
an identity of the relay wireless communication terminal;
an identity of the IoT wireless communication terminal; or
a range of candidate identities to allow the relay wireless communication terminal to allocate one of the candidate identities to the IoT wireless communication terminal.

Preferably or in some embodiments, the wireless communication forwards a capability of a relay function for the IoT wireless communication terminal from the relay wireless communication terminal to a network node.

Preferably or in some embodiments, the relay wireless communication forwards an IoT relay service authorization for a relay function for the IoT wireless communication terminal from a network node to the relay wireless communication terminal, wherein IoT relay service authorization comprises at least one of:
an indication indicating whether the relay wireless communication terminal is authorized to support relaying the IoT information for the IoT relay wireless communication terminal;
an indication indicating whether the relay wireless communication terminal is authorized to support an inventory procedure for the IoT wireless communication terminal;
an indication indicating whether the relay wireless communication terminal is authorized to support an energy supply for the IoT wireless communication terminal;
an indication indicating a relay architecture that the relay wireless communication terminal is authorized to support by the relay wireless communication terminal;
an IoT relay Aggregate Maximum Bit Rate, AMBR, used by the wireless communication node for a resource management of the relay wireless communication terminal relaying the IoT information in a network scheduled mode; or
IoT relay quality of service, QoS, parameters for an IoT relay communication used by the wireless communication node for a resource management for the relay wireless communication terminal relaying the IoT information in a network scheduled mode.

Preferably or in some embodiments, the IoT wireless communication terminal is wake up or triggered an inventory procedure by the relay wireless communication terminal.

Preferably or in some embodiments, the IoT wireless communication terminal receives energy supplied by the relay wireless communication terminal.

Preferably or in some embodiments, the IoT wireless communication terminal performs the communication between the wireless communication node and the IoT wireless communication terminal according to at least one of an identity of the relay wireless communication terminal or an identity of the IoT wireless communication terminal received from the relay wireless communication terminal.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of an IoT relay communication according to an embodiment of the present disclosure.

FIG. 2 shows a schematic diagram of an IoT relay communication according to an embodiment of the present disclosure.

FIG. 3 shows a schematic diagram of an IoT relay communication according to an embodiment of the present disclosure.

FIG. 4 shows a schematic diagram of an IoT relay communication according to an embodiment of the present disclosure.

FIG. 5 shows a schematic diagram of an IoT relay communication according to an embodiment of the present disclosure.

FIG. 6 shows an example of a schematic diagram of a wireless communication terminal according to an embodiment of the present disclosure.

FIG. 7 shows an example of a schematic diagram of a wireless communication node according to an embodiment of the present disclosure.

FIGS. 8 to 10 show flowcharts of wireless communication methods according to some embodiments of the present disclosure.

### DETAILED DESCRIPTION

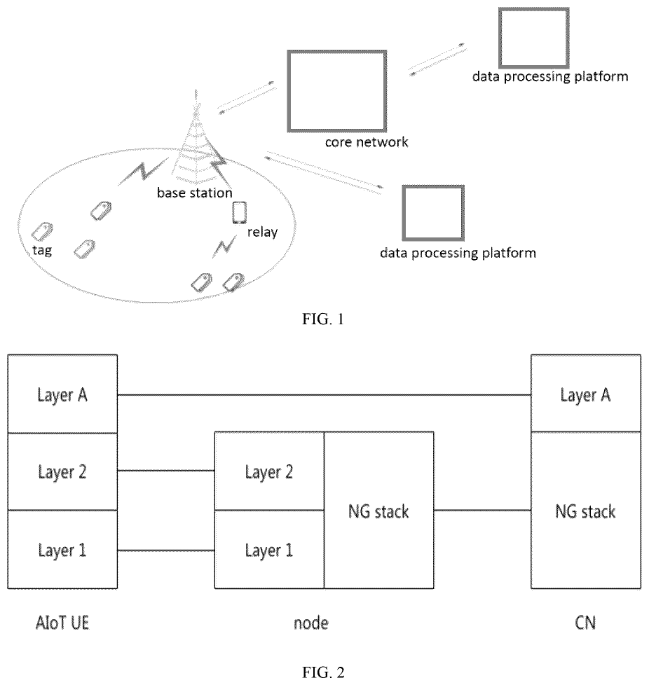

In some embodiments, a large-scale deployment of IoT may be limited by sensor energy consumption, deployment, and maintenance costs. Wireless powered communication network (WPCN), also known as passive IoT, may be a breakthrough for solving such IoT application scenarios. FIG. 1 shows a wireless powered communication network according to an embodiment of the present disclosure.

As illustrated in FIG. 1, the data processing platform is responsible for managing, operating, and maintaining tag data. The core network is responsible for conveying the data from the data processing platform to the base station, or conveying the data from the base station to the data processing platform. The base station may be responsible for the operations on the tags and sending the data from the core network to the tags or sending the tag data to the core network. In scenarios with relays, the relays may be responsible for converting base station commands into commands that tags can recognize and sending them to the tags.

In some embodiments, an IoT UE (user equipment) (e.g., an Ambient Internet of Things (AIoT) UE) has the characteristic of low power consumption, simple protocol stack. The network that supports an access service for this UE also has the characteristic of simple protocol stack. The architecture of this network may be called as the network architecture with a simple stack.

In some embodiments, the IoT Uu interface is between the IoT UE and the node (such as gNB or BS (base station)). In FIG. 2, the Uu Layer 1 entity and the Uu Layer 2 entity are terminated between the IoT UE and the node. The Layer A entity is terminated between the UE and the network function (e.g., a network node) of the core network (such as an AMF (Access and Mobility Management Function)). The NG (next generation) stack(s) are terminated between the node and the network function of the core network (such as AMF). The term entity used in this document indicates an entity or a function performs certain protocol(s) or operation(s), which can be implemented by using a hardware platform and/or a program code.

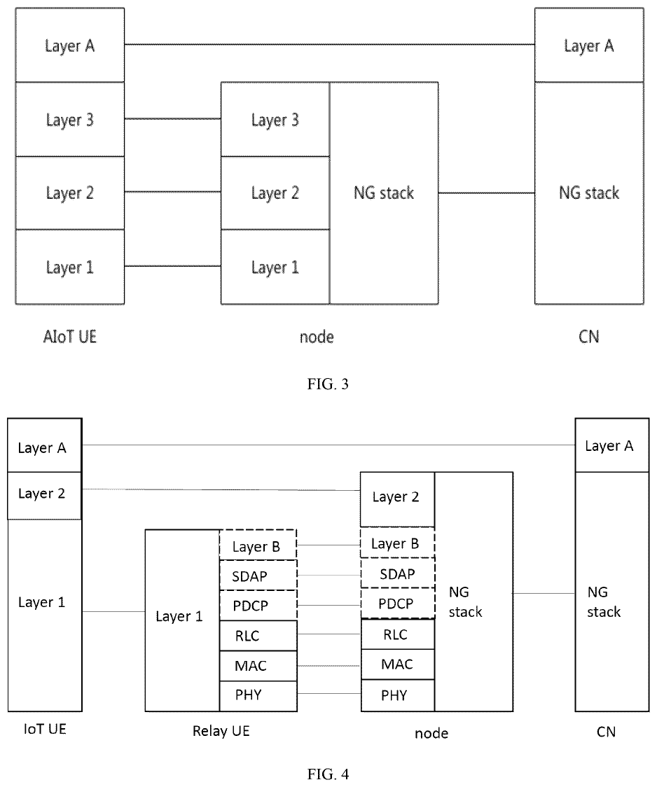

In FIG. 3, the Uu Layer 1 entity, the Uu Layer 2 entity and the Uu Layer 3 entity are terminated between the IoT UE and the node. The Layer A entity is terminated between the IoT UE and the network function of the core network (such as AMF). The NG stack(s) are terminated between the node and the network function of the core network (such as AMF).

In some embodiments, the functions of the Uu Layer 1 entity include at least one of the following: modulation and demodulation, channel coding and decoding, signal generation, physical layer procedures, or physical layer measurement.

In some embodiments, the functions of the Uu Layer 2 entity include at least one of the following: data transfer, conflict resolution, assembling, disassembling, radio resource selection, encryption, decryption, control procedure, or message generation.

In some embodiments, the functions of the Uu Layer 3 entity include at least one of the following: encryption, decryption, or control procedure, message generation.

In some embodiments, the functions of the Layer A entity include at least one of the following: encryption, decryption, control procedure, or message generation.

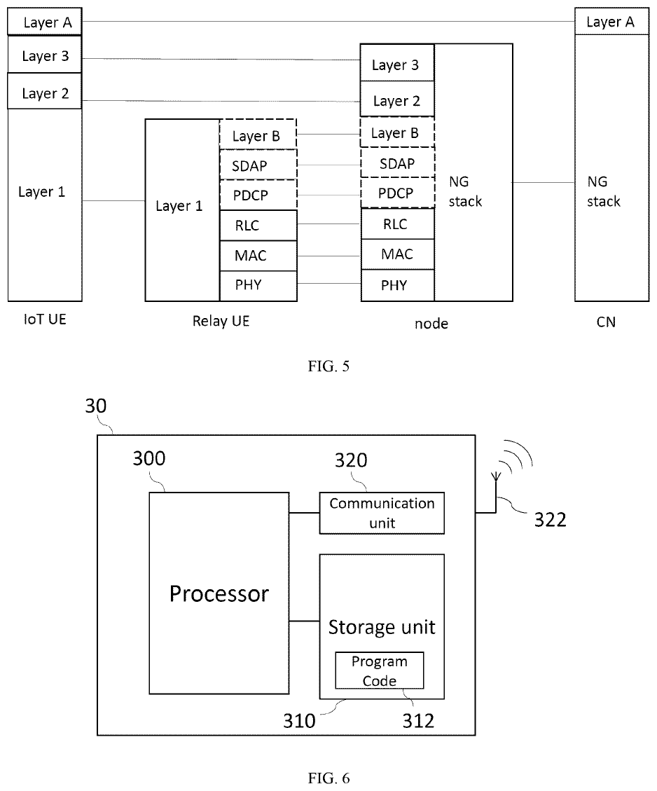

In some embodiments, the power of the IoT UE might be limited, so that the communication distance of the IoT UE is limited. To increase the communication distance, a relay UE (such as an NR UE) may be used to relay the IoT UE's data to the node and/or the core network (see FIGS. 4 and 5).

In some embodiments of the present disclosure, the interface between the IoT UE and the relay UE may be referred to as IoT Uu interface, the interface between the node and the relay UE may be referred to as Uu interface, and the interface between the node and the core network may be referred to as NG interface.

In some embodiments, the functions of the IoT Uu Layer 1 entity (also referred to as IoT Uu Layer 1, IoT Layer 1, or Layer 1) include at least one of the following: modulation and demodulation, channel coding and decoding, signal generation, physical layer procedures, or physical layer measurement.

In some embodiments, the functions of the IoT Uu Layer 2 entity (also referred to as IoT Uu Layer 2, IoT Layer 2, or Layer 2) include at least one of the following: data transfer, conflict resolution, assembling, disassembling, radio resource selection, encryption, decryption, control procedure, or message generation.

In some embodiments, the functions of the IoT Uu Layer 3 entity (also referred to as IoT Uu Layer 3, IoT Layer 3, or Layer 3) include at least one of the following: encryption, decryption, or control procedure, message generation.

In some embodiments, the data that is transmitted between the IoT UE and the core network may be referred to as the CN (core network) PDU (Protocol Data Unit).

In some embodiments, the data that is transmitted between the IoT Layer 1 entity and the IoT Layer 2 entity in the relay UE or IoT UE may be referred to as the Layer 2 PDU.

In some embodiments, the data that is transmitted between the IoT Layer 2 part1 entity and IoT Layer 2 part2 entity in the relay UE or IoT UE may be referred to as the Layer 2 sub-PDU.

In some embodiments, the data that is transmitted between the IoT Layer 2 and Layer 3 entities in the relay UE or IoT UE may be referred to as the Layer 3 PDU.

In the paragraphs below, details will be described along with many aspects, but the present disclosure is not limited to the paragraphs below.

### Aspect 1 (Common Configuration)

In some embodiments, in order to support the communication between the relay UE and the IoT UE, the node may broadcast some information via SIB (System Information block).

This SIB may be a special SIB for the communication between the relay UE and the IoT UE. In some embodiments, if the node supports the communication, the node may broadcast this SIB. In some embodiments, this SIB may be a on demand SIB, if the relay UE needs the information about IoT, the relay UE could trigger a SI (System Information) request procedure to acquire this SIB.

In some embodiments, the information in the SIB could include at least one of:
the frequency for the communication between the relay UE and the IoT UE; in some embodiments, the relay UE and the IoT UE could use this frequency to communicate with each other;
the bandwidth for the communication between the relay UE and the IoT UE;
the indication indicating whether to support the communication between the relay UE and the IoT UE;
the time resource for the communication between the relay UE and the IoT UE, for example, the time resource including at least one of the active duration, the period, or the start time, which could determine the available time for the communication between the relay UE and the IoT UE;
the common configuration of the IoT Uu interface, including one or more of the following:
a) the common configuration of the IoT Layer 1 entity (e.g., the IoT Uu Layer 1 entity), the relay UE and the IoT UE could apply this configuration of the IoT Layer 1 entity, which may include at least one of the modulation, or the rate;
b) the common configuration of the IoT Layer 2 entity (e.g., the IoT Uu Layer 2 entity), the relay UE and the IoT UE could apply this configuration of the IoT Layer 2 entity, which may include at least one of the size of the PDU, the content of the PDU, or the algorithm of contention resolution; and/or
c) the common configuration of the IoT Layer 3 entity (e.g., the IoT Uu Layer 3 entity), the relay UE and the IoT UE could apply this configuration of the IoT Layer 3 entity, which may include at least one of the size of the PDU or the algorithm of the encryption;
the common configuration of the IoT Layer B entity, the relay UE could apply this configuration of the IoT Layer B entity, which may include at least one of the size of the PDU or the size of the header;
the required feedback format, wherein if the IoT UE feedbacks a PDU to the relay UE, the format of feedback may follow the required feedback format, and the required feedback format could include at least one of the content of the feedback, the size of the feedback, or information of the encryption; or
the common configuration of the DRB (Data Radio Bearer) or the SRB (signaling Radio Bearer) or the RB (Radio Bearer) or the RLC (Radio Link Control) channel, comprising at least one of:
a) the common configuration of the DRB, including at least one of: a DRB identity, the configuration of the Uu PHY (physical), the configuration of the Uu MAC (Medium Access Control), the configuration of the Uu RLC, the configuration of the Uu PDCP (Packet Data Convergence Protocol), or the configuration of the Uu SDAP (Service Data Adaption Protocol);
b) the common configuration of the RB, including at least one of: an RB identity, the configuration of the Uu PHY, the configuration of the Uu MAC, the configuration of the Uu RLC, or the configuration of the Uu PDCP; or
c) the common configuration of the RLC channel, including at least one of: an RLC channel identity, the configuration of the Uu PHY, the configuration of the UuMAC, or the configuration of the Uu RLC; or
d) the common configuration of the SRB, including at least one of: an SRB identity, the configuration of the Uu PHY (physical), the configuration of the Uu MAC (Medium Access Control), the configuration of the Uu RLC, the configuration of the Uu PDCP (Packet Data Convergence Protocol), or the configuration of the Uu RRC (Radio Resource Control).

In some embodiments, the relay UE receives the information above via the SIB. In some embodiments, when the relay UE communicates with the IoT UE, the relay UE could apply at least one of the configurations mentioned above.

### Aspect 2 (Dedicated Configuration)

In some embodiments, in order to support the communication between the relay UE and the IoT UE, the node could configure information to the relay UE. In an embodiment, the information can be transmitted via an RRC (Radio Resource Control) message, and the RRC message could be an RRC reconfiguration or another message.

In some embodiments, the information could include at least one of:
the dedicated frequency for the communication between the relay UE and the IoT UE; in some embodiments, the relay UE and the IoT UE could use this frequency to communicate with each other;
the dedicated bandwidth for the communication between the relay UE and the IoT UE;
the enabling indication for the relay UE indicating whether to support the communication between the relay UE and the IoT UE;
the dedicated time resource for the communication between the relay UE and the IoT UE, for example, the time resource including at least one of the active duration, the period, or the start time, which could determine the available time for the communication between the relay UE and the IoT UE;
the release or establishment or modification of one or multiple dedicated configurations of the IoT Uu interface, including one or more of the following:
a) the dedicated configuration of the IoT Layer 1 entity (e.g., the IoT Uu Layer 1 entity), the relay UE and the IoT UE could apply this configuration of the IoT Layer 1 entity, which may include at least one of the modulation, or the rate;
b) the dedicated configuration of the IoT Layer 2 entity (e.g., the IoT Uu Layer 2 entity), the relay UE and the IoT UE could apply this configuration of the IoT Layer 2 entity, which may include at least one of the size of the PDU, the content of the PDU, or the algorithm of contention resolution; and/or
c) the dedicated configuration of the IoT Layer 3 entity (e.g., the IoT Uu Layer 3 entity), the relay UE and the IoT UE could apply this configuration of the IoT Layer 3 entity, which may include at least one of the size of the PDU or the algorithm of the encryption;
the release or establishment or modification of the dedicated configuration of the IoT Layer B entity, the relay UE could apply this configuration of the IoT Layer B entity, which may include at least one of the size of the PDU or the size of the header;
the required feedback format, wherein if the IoT UE feedbacks a PDU to the relay UE, the format of feedback may follow the required feedback format, and the required feedback format could include at least one of the content of the feedback, the size of the feedback, or information of the encryption; or
the dedicated configuration for relaying the data packet from the IoT UE to the node, comprising at least one of:
a) the release or establishment or modification of one or multiple dedicated configuration of the DRB, including one or more of the following: the DRB identity, the configuration of the Uu PHY, the configuration of Uu MAC, the configuration of Uu RLC, the configuration of Uu PDCP and optional configuration of Uu SDAP;
b) the release or establishment or modification of one or multiple dedicated configuration of the RB, including one or more of the following: the RB identity, the configuration of the Uu PHY, the configuration of Uu MAC, the configuration of Uu RLC, and the configuration of Uu PDCP;
c) the release or establishment or modification of one or multiple dedicated configuration of the SRB (Signal Radio Bearer), including one or more of the following: the SRB identity, the configuration of the Uu PHY, the configuration of Uu MAC, the configuration of Uu RLC, and the configuration of Uu RRC;
d) the release or establishment or modification of one or multiple dedicated configuration of the RLC channel, including one or more of the following: the identity of the RLC channel, the configuration of the Uu PHY, the configuration of MAC, and the configuration of RLC;
e) the indication indicating the relaying function;
f) the mapping relationship between the DRB, the SRB, the RB or the RLC channel and the IoT Layer 1, Layer 2 or Layer 3 (e.g., the IoT Uu Layer 1, Layer 2 or Layer 3 entity or function).

In some embodiments, the relay UE receives the information above via the RRC message and applies at least one of the configurations mentioned above.

### Aspect 3 (Layer B)

In some embodiments, in the uplink (UL) transmission, the relay UE relays the data packet from the IoT UE to the node and/or the core network. In some embodiments, the relay UE may deliver the data packet received by IoT Uu Layer 1 or Layer 2 or Layer 3 entity or function to the DRB or the SRB or the RB or the RLC channel in Uu interface. In downlink (DL), the relay UE may deliver the data packet received from the Uu SDAP or RRC or PDCP or RLC to the IoT Uu Layer 1 or Layer 2 or Layer 3 entity or function. In some embodiments, the Layer B entity is used to mapping the data packet from the IoT Uu interface to the Uu interface.

In some embodiments, the relay UE could relay data packets from multiple IoT UEs to the node and/or the core network. In order to save the radio resource in the Uu interface, a DRB or SRB or RB or RLC channel could process the data packets from multiple IoT UEs. In some embodiments, the Layer B entity could map the data packets from multiple IoT UEs to a DRB, an SRB, a n RB, or an RLC channel in the UL transmission, and map the data packet from an SRB, a DRB, an RB, or an RLC channel to multiple IoT UEs.

In some embodiments, for the relay UE, a DRB, an SRB, an RB, or an RLC channel is configured to transmit the data packet from one or multiple IoT UEs. In uplink, if the relay UE receives UL signals from an IoT UE and restores a Layer X PDU (such as Layer 2 PDU, Layer 2 sub-PDU, Layer 3 PDU), it may deliver this Layer X PDU to the Uu SDAP of the corresponding DRB, or the Uu RRC of the corresponding SRB, or the Uu PDCP of the corresponding RB, or the Uu RLC of the corresponding RLC channel by the Layer B entity. In downlink, if the relay UE receives the data packet from the configured DRB or SRB or RB or RLC channel, and restores a Layer X PDU retrieved from the Uu SDAP or RRC or PDCP or RLC PDU, it may deliver this Layer X PDU to the corresponding IoT Uu Layer 1 or layer 2 or Layer 3 by the Layer B entity.

In some embodiments, for the node, a DRB, an SRB, an RB, or an RLC channel is configured to transmit the data packet from one or multiple IoT UEs. In uplink, if the node receives UL signals from a data packet from the configured DRB or SRB or RB or RLC channel, and restores a Layer X PDU retrieved from the Uu SDAP or RRC or PDCP or RLC PDU, the node may deliver this Layer X PDU to the IoT Uu Layer 2 or Layer 3 by the Layer B entity. In downlink, if the node receives the data packet of the IoT UE from the core network, and restores a Layer X PDU, it may deliver this Layer X PDU to IoT Uu Layer 1 or Layer 2 or Layer 3 by the Layer B.

In some embodiments, if a DRB, an SRB, an RB, or an RLC channel is configured to transmit the data packet from multiple IoT UEs, the node and the relay UE may distinguish the IoT UE and transmit the data packet to the corresponding IoT UE. In order to the distinguish the IoT UE, the information about the IoT UE could be added in the Layer X PDU by the Layer B, and the information about the IoT UE could be the identity of the IoT UE. In uplink, the relay UE may add a header (e.g., a Layer B header) carrying the identity of the IoT UE to the Layer X PDU by the Layer B, the node may parse and remove the header, and obtain the identity of the IoT UE by the Layer B. In downlink, the node may add a header carrying the identity of the IoT UE to the Layer X PDU by the Layer B, the relay UE may parse and remove the header, and obtain the identity of the IoT UE by the Layer B.

In some embodiments, the Layer B could support at least one of the following functions:
data transfer;
mapping between the data packet from the IoT UE and the DRB or RB or RLC channel;
adding a header carrying the information about the IoT UE to a LayerX PDU of this IoT UE (e.g., from the IoT Uu Layer 1 or Layer 2 or Layer 3 of the IoT UE); or
parsing and removing a header carrying the information about the IoT UE of a LayerX PDU of this IoT UE.

### Aspect 4 (Authorization)

In some embodiments, the relay UE could indicate the capability about the relaying function (also referred to as relay function) for the IoT UE in the UE capability, and report the capability about the relaying function to the node and/or the core network, so that the node and/or the core network can acknowledge the relay UE's capability about the relaying function. In some embodiments, the relaying function may indicate relaying information for the connection between the IoT UE and the node.

In some embodiments, the UE capability could include the capability about the relay function for the IoT UE. In some embodiments, the capability about the relay function could include at least one of:
whether the UE supports the relay function for the IoT UE;
whether the relay UE an inventory procedure for the IoT UE; for example, the relay UE could support to trigger and control the inventory procedure for the IoT UE;
whether the relay UE the energy supply; for example, the relay UE could support to transmit energy signals to the IoT UE; or
which relay architecture the relay UE supports; for example, the relay UE could support the Layer 2 relay architecture (e.g., the IoT UE has the IoT Uu Layer 1 and Layer 2) and/or the Layer 3 relay architecture (e.g., the IoT UE has the IoT Uu Layer 1, Layer 2, and Layer 3).

In some embodiments, the relay UE could be authorized to perform the IoT relay services by the core network. In some embodiments, the IoT relay service may indicate the IoT relay function. In the NAS (Non-access stratum) procedure, such as the Registration procedures, the relay UE could report it capability about the relay function for the IoT UE to the core network, and the core network could determine whether to authorize the relay UE to perform the IoT relay services based on the relay UE's capability about the relay function.

In some embodiments, the IoT relay service authorization may be included in the subscription data received from the UDM (Unified Data Management). The IoT relay AMBR (Aggregate Maximum Bit Rate) is also provided to the AMF as part of the subscription data for the IoT relay services. The AMF may store the authorized IoT relay Capability (e.g., the capability about the relay function of the relay UE authorized to perform the IoT relay services).

In some embodiments, the IoT relay service authorization may include at least one of:
an indication indicating whether the relay UE is authorized to support the relay function for the IoT UE;
an indication indicating whether the relay UE is authorized to support an inventory procedure for the IoT UE;
an indication indicating whether the relay UE is authorized to support an energy supply for the IoT UE;
an indication indicating a relay architecture that the relay wireless communication terminal is authorized to support by the relay wireless communication terminal
an IoT relay AMBR (Aggregate Maximum Bit Rate), used by the node for the resource management of relay UE's IoT transmission for the IoT relay services in the network scheduled mode; or
IoT relay QoS (quality of service) parameters for the IoT relay function used by the node for the resource management for the IoT relay services in the network scheduled mode.

In some embodiments, the AMF sends the authorized IoT relay Capability to the PCF (Policy Control Function). Based on the received IoT relay Capability from the AMF, the PCF provides the IoT relay QoS (quality of service) parameters for the IoT relay services to the AMF. The AMF stores such information (e.g., the authorized IoT relay Capability and/or the IoT relay QoS parameters for the IoT relay services) as a part of the UE context.

In some embodiments, if the relay UE is authorized to perform the IoT relay services, the AMF may include in an NGAP (Next Generation Application Protocol) message carrying the IoT relay authorization information sent to the node, the IoT relay authorization information could include one or more of the following:
whether the UE supports the relay function for the IoT UE;
whether the relay UE supports the inventory procedure; for example, the relay UE could support to trigger and control the inventory procedure;
whether the relay UE support energy supply; for example, the relay UE could support to transmit energy signals to the IoT UE;
which relay architecture the relay UE supports; for example, the relay UE could support the Layer 2 or Layer 3 relay architecture;
the IoT relay AMBR, which may be used by the node for the resource management of relay UE's IoT transmissions for the IoT relay services in the network scheduled mode; or
the IoT relay QoS parameters for the IoT relay used by the node for the resource management for the IoT relay services in the network scheduled mode.

### Aspect 5 (UE Information)

In some embodiments, the node may trigger the relay UE to report the UE information.

In some embodiments, the node could send a message (e.g., an RRC message) to the relay UE, and the message could include a UE information request, an RRC reconfiguration or another message. The message (e.g., indication information) could include one or more of the following:
the indication that the relay UE could report whether it is interested or no longer interested to receive or transmit the IoT relay communication;
the indication that the relay UE could report whether it is interested or no longer interested to the inventory procedure (e.g., to trigger and control the inventory procedure);
the indication that the relay UE could report whether it is interested or no longer interested in supplying energy for the IoT UE;
the indication that the relay UE could report whether it could request an assignment or release of the transmission resource for the IoT relay communication; for example, the information about requesting assignment or release of the frequency for the IoT relay communication;
the indication that the relay UE could report whether it could request or release (or stop) supplying energy for the IoT UE;
the indication that the relay UE could report whether it could request or release (or stop) the inventory for the IoT UE; or
the indication that the relay UE could report the information about reporting QoS parameters and QoS profile(s) related to the IoT relay communication, for example, the QoS parameters for the IoT relay communication.

In some embodiments, the relay UE could send some assistance information to the node and help the node to trigger the IoT relay communication (e.g., relaying IoT data between the IoT UE and the node) between the relay UE and the IoT UE. In some embodiments, a relay UE, which is capable of the IoT relay communication, upon successful connection establishment or resuming, upon changes of interest, upon changing QoS profile(s), or upon changing to a PCell (primary cell) providing the SIB including a common configuration about IoT relay, may initiate the procedure to request an assignment of the dedicated configuration for the IoT relay communication.

In some embodiments, the relay UE could send a message (e.g., an RRC message) to the node, and the message could include UE assistance information, UE information response or another message. The message could include the one or more of the following:
the indication that the relay UE is interested or no longer interested to receive or transmit the IoT relay communication;
the indication that the relay UE is interested or no longer interested to the inventory procedure (e.g., to trigger and control the inventory procedure);
the indication that the relay UE is interested or no longer interested in supplying energy for the IoT UE;
the information about requesting an assignment or release of the transmission resource for the IoT relay communication; for example, the information about requesting assignment or release of the frequency for the IoT relay communication;
the information about requesting or releasing (or stopping) supplying energy for the IoT UE;
the indication requesting or releasing (or stopping) the inventory for the IoT UE; or
the information about reporting QoS parameters and QoS profile(s) related to the IoT relay communication, for example, the QoS parameters for the IoT relay communication.

### Aspect 6 (Inventory)

In some embodiments, the node could trigger the relay UE to wake up or inventory the IoT UE. When the node determines to trigger the IoT relay communication between the relay UE and the IoT UE, the node could send a message to the relay UE. The relay UE receives this message, and accordingly wakes up the IoT UE or trigger an inventory procedure for the IoT UE.

In some embodiments, the message could be an RRC reconfiguration or other RRC message. In some embodiments, the message could carry the information including one or more of the following:
the indication enabling the wake-up signal;
the time information about the wake-up signal, such as the starting time, the periodicity, and/or the duration;
the configuration of the wake-up signal, such as the modulation and/or the rate;
the information about the inventory, such as the identity about the IoT UE;
the information about the contention resolution, such as, the contention algorithm, the Q (quality) value, the time range that the IoT UE feedback; or
a PDU that may carry the information about the inventory, the contention resolution, and so on.

### Aspect 7 (Energy Supply)

In some embodiments, the node could trigger the relay UE to supply energy for the IoT UE. When the node determines to charge the IoT UE, the node could select a relay UE and trigger this relay UE to supply energy for the IoT UE. When the relay UE receives this triggering signal, the relay UE could transmit energy signals to the IoT UE, and the IoT UE could be charged based on those energy signals.

In some embodiments, the node may transmit a message including the triggering signal to the relay UE.

In some embodiments, the message can be an RRC message, such as RRC reconfiguration. In some embodiments, the message could carry some information about the energy signals.

In some embodiments, the information could include at least one of:
the triggering signals;
the indication that enabling the energy signals;
the physical configuration, such as the modulation, the waveform, and/or the rate;
the power level of the power to be transmitted (e.g., the power level of the energy signal);
the type of the energy signals, such as OOK (On-Off Keying) signals; or
time information, such as the starting time, the periodicity, and/or the duration.

In some embodiments, when the relay UE receives this message, the relay UE starts to transmit the energy signals according to the message.

In some embodiments, the triggering signals could be carried in a MAC CE (Medium Access Control Control Element,). The node could configure the energy signals via the RRC message, the RRC message carry the information as described above, and the node could enable or disable the transmission of the energy signals via the MAC CE. The MAC CE could carry some information about the energy signals.

In some embodiments, the information could include at least one of:
the indication enabling or disabling the energy signal; if enabling the energy signals, the relay UE could start to transmit the energy signal; and if disabling the energy signals, the relay UE could stop transmitting the energy signals;
the power level of the power to be transmitted;
the type of the energy signals, such as OOK signals; or
the time information, such as the starting time, the periodicity, and/or the duration, in which the starting time could be an offset of the transmission occasion of the MAC CE, or an offset of the effective time of the MAC CE.

In some embodiments, the triggering signals could be carried in DCI (Downlink Control Information). The node could configure the energy signals via the RRC message. The RRC message may carry the information as described above, and the node could enable or disable the transmission of the energy signals via the DCI. The DCI could carry some information about the energy signals. In some embodiments, the information could include at least one of:
the indication enabling or disabling the energy signal; if enabling the energy signals, the relay UE could start to transmit the energy signal; and if disabling the energy signals, the relay UE could stop transmitting the energy signals;
the power level of the power to be transmitted;
the type of the energy signals, such as OOK signals; or
the time information, such as the starting time, the periodicity, and/or the duration, in which the starting time could be an offset of the transmission occasion of the DCI, or an offset of the effective time of the DCI.

### Aspect 8 (Identity)

In some embodiments, when the relay UE communicates with the IoT UE, another IoT UE may communicate with another relay UE, causing interference for the relay UEs. In order to avoid the interference, the information could be carried in the PDU(s). The information could include the identity of the relay UE and/or the IoT UE.

In some embodiments, the node could allocate an identity for the relay UE. The node could indicate an identity for the relay UE via an RRC message, such as an RRC reconfiguration message. The relay UE could use this identity when the relay UE communicates with the IoT UE. The relay UE could carry this identity in the PDU that is sent to the IoT UE. The IoT UE could use this identity when the IoT UE communicates with the relay UE. The IoT UE could carry this identity in the PDU that is sent to relay UE.

In some embodiments, the node could allocate an identity for the IoT UE. The node could indicate an identity for the IoT UE to the relay UE via an RRC message, such as an RRC reconfiguration message. The relay UE could use this identity when the relay UE communicates with this IoT UE. The relay UE could carry this identity in the PDU that is sent to the IoT UE. The IoT UE could use this identity when the IoT UE communicates with the relay UE. The IoT UE could carry this identity in the PDU that is sent to the relay UE.

In some embodiments, the node could allocate a range of the identity for IoT UEs. The node could indicate a range of the identity for IoT UEs to the relay UE via an RRC message, such as an RRC reconfiguration message. The relay UE could allocate an identity for an IoT UE within the range of the identity when the relay UE communicates with this IoT UE. The relay UE could carry this identity in the PDU that is sent to the IoT UE. The IoT UE could use this identity when the IoT UE communicates with the relay UE. The IoT UE could carry this identity in the PDU that is sent to the relay UE.

In the paragraphs below, details will be described along with some examples, but the present disclosure is not limited to the example below.

FIG. 6 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the relay UE or the IoT UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node or another wireless communication terminal 30.

In some embodiments, the wireless communication terminal 30 may be used to perform the operations of the relay UE or the IoT UE described above. In some embodiments, the processor 300 and the communication unit 320 collaboratively perform the operations described above. For example, the processor 300 performs operations and transmit or receive signals, message, and/or information through the communication unit 320.

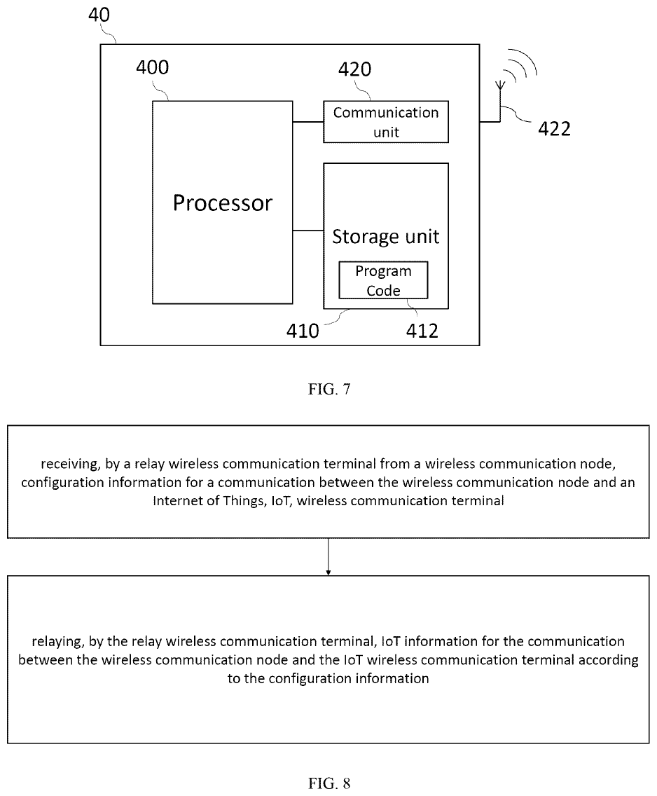

FIG. 7 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the node, the core network, the network functions (e.g., the AMF, the PCF, etc.), or a network node in the core network described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

In some embodiments, the wireless communication node 40 may be used to perform the operations of the node, the core network, the network functions (e.g., the AMF, the PCF, etc.), or a network node in the core network described in this disclosure. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a relay UE). In an embodiment, the wireless communication terminal may be implemented by using the wireless communication terminal 40 described above, but is not limited thereto.

Referring to FIG. 8, in an embodiment, the wireless communication method includes: receiving, by a relay wireless communication terminal from a wireless communication node, configuration information for a communication between the wireless communication node and an Internet of Things, IoT, wireless communication terminal; and relaying, by the relay wireless communication terminal, IoT information for the communication between the wireless communication node and the IoT wireless communication terminal according to the configuration information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a node). In an embodiment, the wireless communication node may be implemented by using the wireless communication node 50 described above, but is not limited thereto.

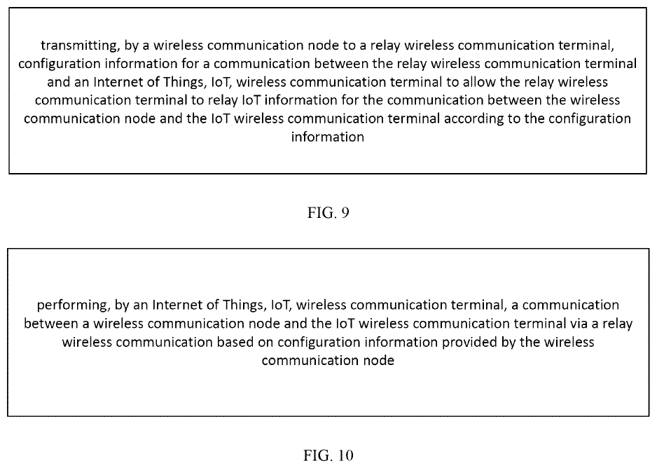

Referring to FIG. 9, in an embodiment, the wireless communication method includes transmitting, by a wireless communication node to a relay wireless communication terminal, configuration information for a communication between the relay wireless communication terminal and an Internet of Things, IoT, wireless communication terminal to allow the relay wireless communication terminal to relay IoT information for the communication between the wireless communication node and the IoT wireless communication terminal according to the configuration information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., an IoT UE). In an embodiment, the wireless communication terminal may be implemented by using the wireless communication terminal 40 described above, but is not limited thereto.

Referring to FIG. 10, in an embodiment, the wireless communication method includes: performing, by an Internet of Things, IoT, wireless communication terminal, a communication between a wireless communication node and the IoT wireless communication terminal via a relay wireless communication based on configuration information provided by the wireless communication node.

Details in this regard can be ascertained with reference to the paragraphs above, and will not be repeated herein.

In some embodiments, the IoT information used in the present disclosure may include at least one of: information of the IoT wireless communication terminal, information of the wireless communication node, information for the connection between the wireless communication node and the IoT wireless communication terminal, a configuration for the IoT wireless communication terminal, the data collected by the IoT wireless communication terminal, or an instruction for reading the data collected by the IoT wireless communication terminal.

In some embodiments, the IoT wireless communication terminal used in the present disclosure may indicate the IoT UE described above.

In some embodiments, the relay wireless communication terminal used in the present disclosure may indicate the relay UE described above.

In some embodiments, the wireless communication node used in the present disclosure may indicate the node, BS, or gNB described above.

In some embodiments, the configuration information used in the present disclosure may indicate the common configuration and/or the dedicated configuration described above.

In some embodiments, the relay function used in the present disclosure may indicate the relay wireless communication terminal relaying the IoT information for the communication between the wireless communication node and the IoT wireless communication terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a relay wireless communication terminal from a wireless communication node, configuration information for a communication between the wireless communication node and an Internet of Things (IoT) wireless communication terminal; and
relaying, by the relay wireless communication terminal, IoT information for the communication between the wireless communication node and the IoT wireless communication terminal according to the configuration information.

2. The wireless communication method of claim 1, wherein the configuration information comprises at least one of:
frequency information for the communication between the wireless communication node and the IoT wireless communication terminal according to the configuration information;
bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a time resource for the communication between the wireless communication node and the IoT wireless communication terminal according to the configuration information;
a common configuration of an IoT Uu interface;
a common configuration of an IoT Layer B entity;
a required feedback format; or
a common configuration of at least one of a Data Radio Bearer (DRB), a Signaling Radio Bearer (SRB), a Radio Bearer (RB), or a Radio Link Control (RLC) channel.

3. The wireless communication method of claim 2, wherein the common configuration of the IoT Uu interface comprises at least one of:
a common configuration of an IoT Layer 1 entity;
a common configuration of an IoT Layer 2 entity; or
a common configuration of an IoT Layer 3 entity.

4. The wireless communication method of claim 2, wherein the configuration information conforms with at least one of:
the common configuration of the DRB comprising at least one of: a Uu physical (PHY) configuration, a Uu Medium Access Control (MAC) configuration, a Uu RLC configuration, a Uu Packet Data Convergence Protocol (PDCP) configuration, a Uu Service Data Adaption Protocol (SDAP) configuration, or a DRB identity;
the common configuration of the SRB comprising at least one of: a Uu physical, PHY, configuration, a Uu MAC configuration, a Uu RLC configuration, a Uu PDCP configuration, a Uu Radio Resource control (RRC) configuration, or an SRB identity;
the common configuration of the RB comprising at least one of: a Uu PHY configuration, a Uu MAC configuration, a Uu RLC configuration, a Uu PDCP configuration, or an RB identity; or
the common configuration of the RLC channel comprising at least one of: a Uu PHY configuration a Uu MAC configuration, a Uu RLC configuration, or an RLC channel identity.

5. The wireless communication method of claim 1, wherein the configuration information comprises at least one of:
dedicated frequency information for the communication between the wireless communication node and the IoT wireless communication terminal according to the configuration information;
dedicated bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a dedicated time resource for the communication between the wireless communication node and the IoT wireless communication terminal according to the configuration information;
an indication of a release, an establishment, or a modification of one or more dedicated configurations of an IoT Uu interface;
an indication of a release, an establishment, or a modification of a dedicated configuration of an IoT Layer B entity;
a required feedback format; or
a dedicated configuration for relaying a data packet from the relay wireless communication terminal to the IoT wireless communication terminal.

6. The wireless communication method of claim 5, wherein the one or more dedicated configurations of the IoT Uu interface comprises at least one of:
a dedicated configuration of an IoT Layer 1 entity;
a dedicated configuration of an IoT Layer 2 entity; or
a dedicated configuration of an IoT Layer 3 entity.

7. The wireless communication method of claim 5, wherein the dedicated configuration for relaying the data packet comprises at least one of:
an indication of a release, an establishment, or a modification of one or more dedicated configurations of a DRB;
an indication of a release, an establishment, or a modification of one or more dedicated configurations of an RB;
an indication of a release, an establishment, or a modification of one or more dedicated configurations of an SRB;
an indication of a release, an establishment, or a modification of one or more dedicated configurations of an RLC channel;
an indication indicating a relaying function; or
a mapping relationship between a DRB, SRB, RB or RLC channel and an IoT Layer 1, Layer 2, or Layer 3 entity.

8. The wireless communication method of claim 1, wherein the relay wireless communication terminal transmits a capability of a relay function for the IoT wireless communication terminal to a network node; and
wherein the capability comprises at least one of:
an indication indicating whether the relay wireless communication terminal supports relaying the IoT information the IoT wireless communication terminal;
an indication indicating whether the relay wireless communication terminal supports an inventory procedure for the IoT wireless communication terminal;
an indication indicating whether the relay wireless communication terminal supports an energy supply for the IoT wireless communication terminal; or
an indication indicating a relay architecture supported by the relay wireless communication terminal.

9. The wireless communication method of claim 1, wherein the relay wireless communication terminal receives an IoT relay service authorization for a relay function for the IoT wireless communication terminal from a network node, wherein IoT relay service authorization comprises at least one of:
an indication indicating whether the relay wireless communication terminal is authorized to support relaying the IoT information for the IoT relay wireless communication terminal;
an indication indicating whether the relay wireless communication terminal is authorized to support an inventory procedure for the IoT wireless communication terminal;
an indication indicating whether the relay wireless communication terminal is authorized to support an energy supply for the IoT wireless communication terminal;
an indication indicating a relay architecture that the relay wireless communication terminal is authorized to support by the relay wireless communication terminal;
an IoT relay Aggregate Maximum Bit Rate (AMBR), used by the wireless communication node for a resource management of the relay wireless communication terminal relaying the IoT information in a network scheduled mode; or
IoT relay quality of service (QoS) parameters for an IoT relay communication used by the wireless communication node for a resource management for the relay wireless communication terminal relaying the IoT information in a network scheduled mode.

10. The wireless communication method of claim 1, wherein the relay wireless communication terminal receives indication information from the wireless communication node, and reports assistance information to the wireless communication node based on indication information; and
wherein the indication information comprises at least one of:
an indication indicating that the relay wireless communication terminal is able to report whether it is interested in relaying the IoT information for the communication between the wireless communication node and the IoT wireless communication terminal;
an indication indicating that the relay wireless communication terminal is able to report whether it is interested in an inventory for the IoT wireless communication terminal;
an indication indicating that the relay wireless communication terminal is able to report whether it is interested in supplying energy for the IoT wireless communication terminal;
an indication indicating that the relay wireless communication terminal is able to request or release a transmission resource for the communication between the wireless communication node and the IoT wireless communication terminal;
an indication indicating that the relay wireless communication terminal is able to report information of requesting or releasing supplying energy for the IoT wireless communication terminal;
an indication indicating that the relay wireless communication terminal is able to report an indication of requesting or releasing an inventory for the IoT wireless communication terminal; or
an indication indicating that the relay wireless communication terminal is able to report information of quality of service (QoS) parameters and one or more QoS profiles related to relaying the IoT information for the communication between the wireless communication node and the IoT wireless communication terminal.

11. The wireless communication method of claim 10, wherein the assistance information comprises at least one of:
an indication indicating whether the relay wireless communication terminal is interested in relaying the IoT information for the communication between the wireless communication node and the IoT wireless communication terminal;
an indication indicating whether the relay wireless communication terminal is interested in an inventory for the IoT wireless communication terminal;
an indication indicating whether the relay wireless communication terminal is interested in supplying energy for the IoT wireless communication terminal;
information of requesting or releasing a transmission resource for relaying the IoT information for the communication between the wireless communication node and the IoT wireless communication terminal;
information of requesting or releasing supplying energy for the IoT wireless communication terminal;
an indication of requesting or releasing an inventory for the IoT wireless communication terminal; or
information of quality of service (QoS) parameters and one or more QoS profiles related to relaying the IoT information for the communication between the wireless communication node and the IoT wireless communication terminal.

12. The wireless communication method of claim 1, wherein the relay wireless communication terminal receives a message from the wireless communication node for at least one of waking up the IoT wireless communication terminal or triggering an inventory procedure for the IoT wireless communication terminal.

13. The wireless communication method of claim 12, wherein the message comprises at least one of:
an indication enabling a wake-up signal for the IoT wireless communication terminal;
time information of a wake-up signal for the IoT wireless communication terminal;
a configuration of a wake-up signal for the IoT wireless communication terminal;
information of the inventory procedure for the IoT wireless communication terminal; or
information of a contention resolution.

14. The wireless communication method of claim 1, wherein the relay wireless communication terminal receives a trigger signal from the wireless communication node and supplies energy to the IoT wireless communication terminal according to the trigger signal; and
wherein the trigger signal comprises at least one of:
an indication enabling or disabling an energy signal supplying energy to the IoT wireless communication terminal;
a physical configuration of an energy signal supplying energy to the IoT wireless communication terminal;
a power level of an energy signal supplying energy to the IoT wireless communication terminal;
a signal type of an energy signal supplying energy to the IoT wireless communication terminal; or
time information of an energy signal supplying energy to the IoT wireless communication terminal.

15. The wireless communication method of claim 1, wherein the relay wireless communication terminal receives identity information from the wireless communication node and relaying the IoT information for the communication between the wireless communication node and the IoT wireless communication terminal according to the identity information; and
wherein the identity information comprises at least one of:
an identity of the relay wireless communication terminal;
an identity of the IoT wireless communication terminal; or
a range of candidate identities to allow the relay wireless communication terminal to allocate one of the candidate identities to the IoT wireless communication terminal.

16. A wireless communication method comprising:
transmitting, by a wireless communication node to a relay wireless communication terminal, configuration information for a communication between the relay wireless communication terminal and an Internet of Things (IoT) wireless communication terminal to allow the relay wireless communication terminal to relay IoT information for the communication between the wireless communication node and the IoT wireless communication terminal according to the configuration information.

17. A wireless communication method comprising:
performing, by an Internet of Things (IoT) wireless communication terminal, a communication between a wireless communication node and the IoT wireless communication terminal via a relay wireless communication terminal based on configuration information provided by the wireless communication node.

18. The wireless communication method of claim 17, wherein the configuration information comprises at least one of:
frequency information for the communication between the wireless communication node and the IoT wireless communication terminal according to the configuration information;
bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a time resource for the communication between the wireless communication node and the IoT wireless communication terminal according to the configuration information;
a common configuration of an IoT Uu interface;
a common configuration of an IoT Layer B entity;
a required feedback format; or
a common configuration of at least one of a Data Radio Bearer (DRB), a Signaling Radio Bearer (SRB), a Radio Bearer (RB), or a Radio Link Control (RLC) channel; and
wherein the common configuration of the IoT Uu interface comprises at least one of:
a common configuration of an IoT Layer 1 entity;
a common configuration of an IoT Layer 2 entity; or
a common configuration of an IoT Layer 3 entity; and
wherein the configuration information conforms with at least one of:
the common configuration of the DRB comprising at least one of: a Uu physical (PHY), configuration, a Uu Medium Access Control (MAC) configuration, a Uu RLC configuration, a Uu Packet Data Convergence Protocol (PDCP) configuration, a Uu Service Data Adaption Protocol (SDAP) configuration, or a DRB identity;
the common configuration of the SRB comprising at least one of: a Uu PHY configuration, a Uu MAC configuration, a Uu RLC configuration, a Uu PDCP configuration, a Uu Radio Resource control (RRC) configuration, or an SRB identity;
the common configuration of the RB comprising at least one of: a Uu PHY configuration, a Uu MAC configuration, a Uu RLC configuration, a Uu PDCP configuration, or an RB identity; or
the common configuration of the RLC channel comprising at least one of: a Uu PHY configuration a Uu MAC configuration, a Uu RLC configuration, or an RLC channel identity.

19. The wireless communication method of claim 17, wherein the configuration information comprises at least one of:
dedicated frequency information for the communication between the wireless communication node and the IoT wireless communication terminal according to the configuration information;
dedicated bandwidth information for the communication between the wireless communication node and the IoT wireless communication terminal according to the configuration information;
an enabling indication indicating whether the relay wireless communication terminal supporting relaying the IoT information for the communication between the wireless communication node and the IoT wireless communication terminal;
a dedicated time resource for the communication between the wireless communication node and the IoT wireless communication terminal according to the configuration information;
an indication of a release, an establishment, or a modification of one or more dedicated configurations of an IoT Uu interface;
an indication of a release, an establishment, or a modification of a dedicated configuration of an IoT Layer B entity;
a required feedback format; or
a dedicated configuration for relaying a data packet from the relay wireless communication terminal to the IoT wireless communication terminal; and
wherein the one or more dedicated configurations of the IoT Uu interface comprises at least one of:
a dedicated configuration of an IoT Layer 1 entity;
a dedicated configuration of an IoT Layer 2 entity; or
a dedicated configuration of an IoT Layer 3 entity; and
wherein the dedicated configuration for relaying the data packet comprises at least one of:
an indication of a release, an establishment, or a modification of one or more dedicated configurations of a DRB;
an indication of a release, an establishment, or a modification of one or more dedicated configurations of an RB;
an indication of a release, an establishment, or a modification of one or more dedicated configurations of an SRB;
an indication of a release, an establishment, or a modification of one or more dedicated configurations of an RLC channel;
an indication indicating a relaying function; or
a mapping relationship between a DRB, SRB, RB or RLC channel and an IoT Layer 1, Layer 2, or Layer 3 entity.

20. The wireless communication method of claim 17, wherein the IoT wireless communication terminal is wake up or triggered an inventory procedure by the relay wireless communication terminal; and
wherein the IoT wireless communication terminal receives energy supplied by the relay wireless communication terminal; and
wherein the IoT wireless communication terminal performs the communication between the wireless communication node and the IoT wireless communication terminal according to at least one of an identity of the relay wireless communication terminal or an identity of the IoT wireless communication terminal received from the relay wireless communication terminal.
